(19) United States
(12) Patent Application Publication
(10) Pub. No.: US 2013/0135865 A1
(43) Pub. Date: May 30, 2013

(54) HEAT SINK AND LED LAMP USING THE SAME

(71) Applicant: CHU-KENG LIN, Chu-Nan (TW)

(72) Inventor: CHU-KENG LIN, Chu-Nan (TW)

(73) Assignee: FOXSEMICON INTEGRATED TECHNOLOGY, INC., Chu-Nan (TW)

(21) Appl. No.: 13/443,889

(22) Filed: Apr. 11, 2012

(30) Foreign Application Priority Data
Nov. 29, 2011 (TW) 100143821

(51) Int. Cl. F21V 29/00; F21S 4/00; F28F 3/02

(52) U.S. Cl. 362/249.02; 165/185

(57) ABSTRACT

An LED lamp includes a heat sink and a plurality of LEDs. The heat sink includes a base and a plurality of fins. The base includes a first face and a second face opposite to the first face. The fins extend from the first face of the base. Each fin includes two streamline fin branches and a convex portion connecting the two fin branches. Each fin branch has a first end near a middle of the base, and a second end near an outer edge of the base. Each fin branch has a height gradually decreasing from the first end to the second end. The LEDs are attached to the second face of the base, and located corresponding to the convex portions, respectively.

### BACKGROUND

1. Technical Field

The disclosure relates to illuminating devices, and particularly to a light emitting diode (LED) lamp with a heat sink having fins which facilitate both heat dissipation and dust removal.

2. Description of Related Art

LED illumination lamps have been quickly developed in recent years. Compared with traditional illumination devices, the LED illumination lamps have small volume, short response time, long life, low driving voltage and better anti-shock capability.

A conventional LED lamp comprises a heat sink and a plurality of LED modules having LEDs attached to an outer surface of the heat sink. The heat sink dissipates heat generated by the LEDs. However, dust will accumulate on the outer surface of the heat sink when the heat sink used for a long time. If the dust is not duly cleared from the heat sink, a heat dissipation effect of the heat sink will be badly affected.

What is needed, therefore, is a heat sink and an LED lamp using the same which can overcome the described limitations.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED lamp in accordance with an embodiment of the disclosure.

FIG. 2 is an inverted view of the LED lamp of FIG. 1.

FIG. 3 is a top plan view of the LED lamp of FIG. 1.

FIG. 4 is a front side view of the LED lamp of FIG. 1.

FIG. 5 is a left side view of the LED lamp of FIG. 1.

### DETAILED DESCRIPTION

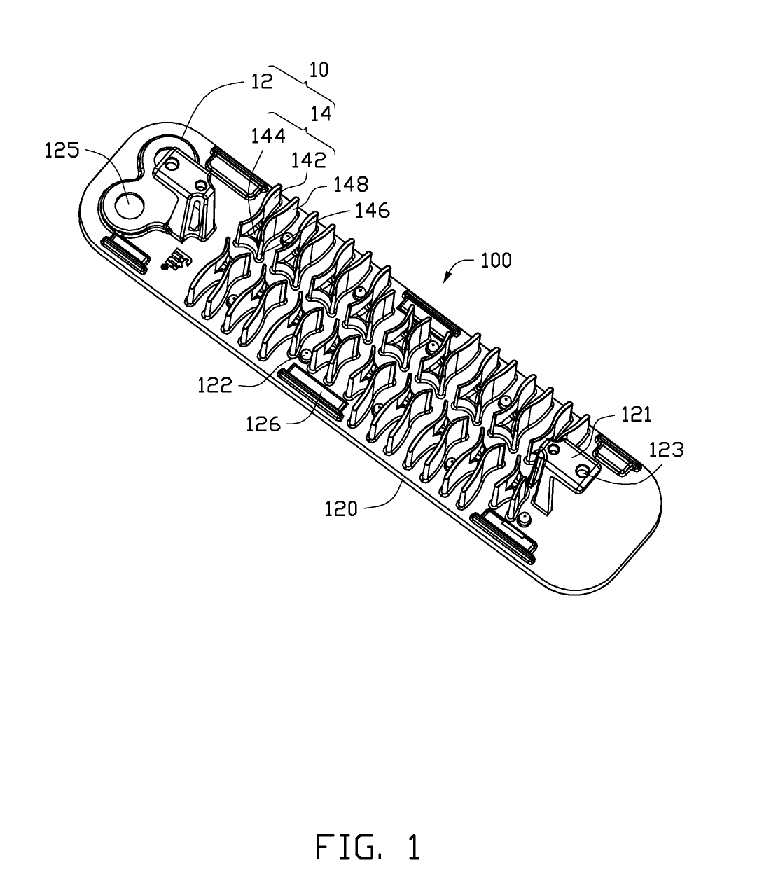

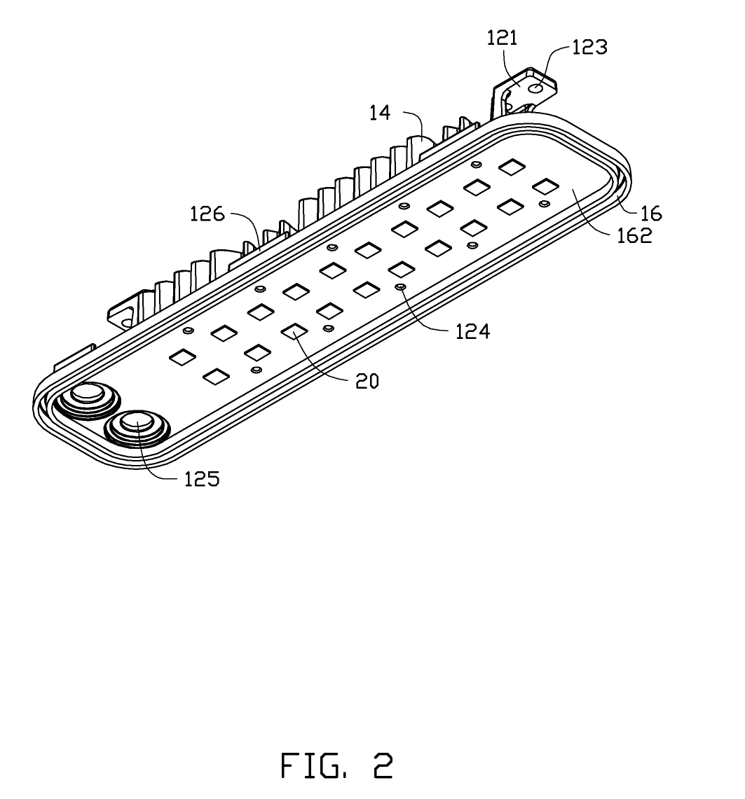

Referring to FIGS. 1-2, an LED lamp 100 in accordance with an embodiment of the disclosure includes a heat sink 10, and a plurality of LEDs 20 attached to a bottom face of the heat sink 10.

The heat sink 10 is made of metal such as aluminum, copper or an alloy thereof. The heat sink 10 includes a substantially rectangular plate-shaped base 12, and a plurality of fins 14 vertically and upwardly extending from a top face of the base 12. The fins 14 are arranged in two rows along a length direction of the base 12.

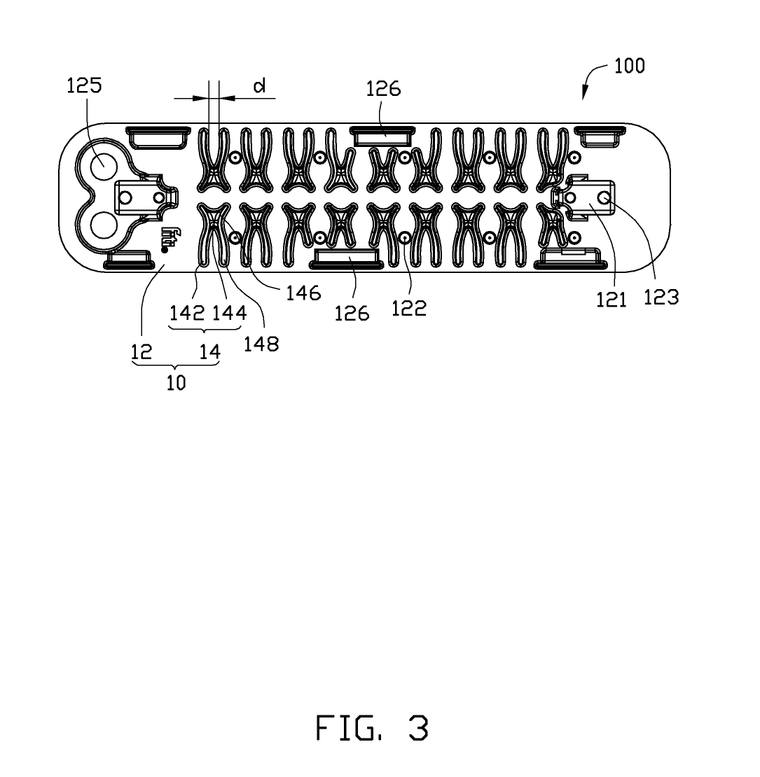

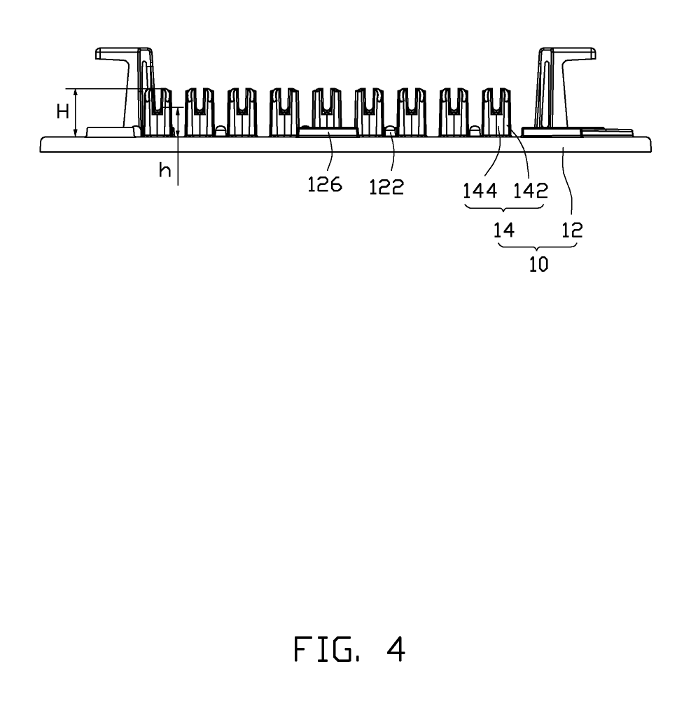

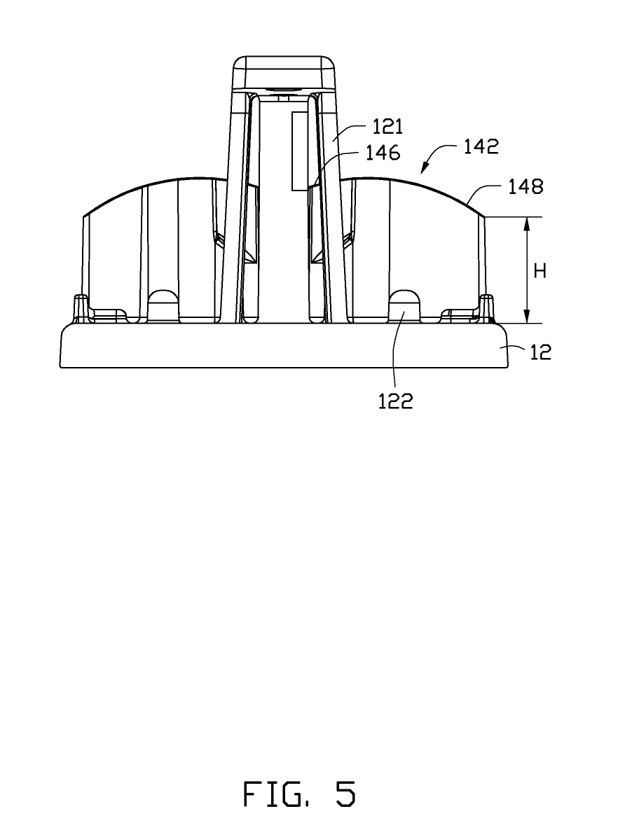

Also referring to FIGS. 3-5, each fin 14 includes two streamline fin branches 142 and a convex portion 144 located between the two fin branches 142. A top surface and two side surfaces of each fin branch 142 are smooth and curved, thereby offering the least resistance to fluid flow. In this embodiment, a cross section of the fin branch 142 parallel to the base 12 is substantially S-shaped. Each fin branch 142 has a first end 146 near a middle of the base 12, and a second end 148 near a long, outer edge 120 of the base 12. A distance d between two fin branches 142 of each fin 14 firstly gradually decreases and then gradually increases from the first end 146 to the second end 148. The convex portion 144 connects the first ends 146 of the two fin branches 142. A top face of the convex portion 144 away from the base 12 is a smooth and curved. The convex portion 144 has a height h less than a height H of each fin branch 142. The height h of the convex portion 144 gradually decreases from the first end 146 to the second end 148 of the each fin branch 142. The height H of each fin branch 142 gradually decreases from the first end 146 to the second end 148. Such structure of the heat sink 10 facilitates guiding water current to rinse and remove dust accumulated on the top face of the base 12 of the heat sink 10 and the fins 14 from the middle of the heat sink 10 to the long, outer edges 120 of the base 12.

A plurality of convex posts 122 located between the fins 14 protrude from the top face of the base 12. A plurality of concave holes 124 are defined in the bottom face of the base 12 corresponding to the convex posts 122. Three rectangular protrusions 126 protrude from the top face of the base 12 near each long, outer edge 120. The concave holes 124 and the protrusions 126 are used for connecting the heat sink 10 with other components of the LED lamp 100, for example, clips (not shown) which fasten a lamp cover (not shown) to the heat sink 10. Two fixing members 121 extend perpendicularly up and then horizontally out from the top face of the base 12 near two opposite ends thereof, for fixing the LED lamp 100 to a support for example, a mounting bracket (not shown) of a supporting post of a road lamp. Two fixing holes 123 are defined in each fixing member 121. The fin branches 142 near the protrusions 126 and the fixing members 121 are smaller than other fin branches 142 to prevent the fin branches 142 from interfering with operations which are applied to the protrusions 126 and the fixing members 121 to secure the lamp cover to the heat sink 10 and the

LED lamp 100 to the mounting bracket. Two circular mounting holes 125 are defined in one end of the base 12 near a short outer edge 120 for extension of electrical wires (not shown) therethrough.

Two annular side walls 16 extend downwardly from the outer edges 120 of the bottom face of the base 12. An inner one of the two annular side walls 16 and the bottom face of the base 12 cooperatively form a receiving groove 162 therebetween. The LEDs 20 are received in the receiving groove 162. The LEDs 20 are positioned to be directly below the convex portions 144, respectively, whereby heat generated by the LEDs 144 can be quickly absorbed and dissipated by the fins 14. A resilient seal (not shown) is received in a space between the two annular side walls 16. When the lamp cover (not shown) is mounted to the heat sink 10, a top edge of the lamp cover extends into the space and presses the resilient seal, whereby the receiving groove 162 can be airtight and watertight by the lamp cover; thus, moisture and water can be prevented from entering receiving groove 162 to damage the LEDs 20.

According to the disclosure, each fin 14 of the heat sink 10 includes two streamline fin branches 142 and a smooth convex portion 144 connecting the two fin branches 142. The height H of each fin branch 142 gradually decreases from the first end 146 to the second end 148. Such structure of the heat sink 10 facilitates guiding water current to rinse and remove dust accumulated on the heat sink 10 from the middle of the base 12 to the outer edges of the base 12. Thus, the heat sink 10 can always function well to remove the heat generated by the LEDs 20.

It is to be understood, however, that even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A heat sink comprising:
a base; and
a plurality of fins extending from the base, each fin comprising two streamline fin branches and a convex portion connecting the two fin branches, each fin branch comprising a first end and a second end opposite to the first end, each fin branch having a height gradually decreasing from the first end to the second end.

2. The heat sink of claim 1, wherein the first and second ends of each fin branch are located near a middle of the base and an outer edge of the base, respectively.

3. The heat sink of claim 1, wherein the base is substantially rectangular plate-shaped, the fins being arranged in two rows along a length direction of the base.

4. The heat sink of claim 1, wherein a distance of two fin branches of each fin firstly gradually decreases and then gradually increases from the first end to the second end.

5. The heat sink of claim 1, wherein the convex portion connects the first ends of the two fin branches of each fin, a top face of the convex portion away from the base being a smooth curve.

6. The heat sink of claim 1, wherein a height of the convex portion is less than a height of each of the two fin branches at two lateral sides of the convex portion.

7. The heat sink of claim 1, wherein a height of the convex portion gradually decreases from the first end to the second end of the each fin branch.

8. The heat sink of claim 1, wherein two annular side walls extend from outer edges of a second face of the base opposite to the fins, an inner one of the two annular side walls of the base and the second face of the base cooperatively forming a receiving groove therebetween, configured for receiving heat-generating components therein.

9. An LED (light emitting diode) lamp comprising:
a plurality of LEDs; and
a heat sink comprising:
a base; and
a plurality of fins extending from the base, the LEDs being attached to the base, each fin comprising two streamline fin branches and a convex portion connecting the two fin branches, each fin branch comprising a first end and a second end opposite to the first end, each fin branch having a height gradually decreasing from the first end to the second end.

10. The LED lamp of claim 9, wherein the first and second ends of each fin branch are located near a middle of the base and an outer edge of the base, respectively.

11. The LED lamp of claim 9, wherein the base is substantially rectangular plate-shaped, the fins being arranged in two rows along a length direction of the base.

12. The LED lamp of claim 9, wherein a distance of two fin branches of each fin firstly gradually decreases and then gradually increases from the first end to the second end.

13. The LED lamp of claim 9, wherein the convex portion connects the first ends of the two fin branches of each fin, a top face of the convex portion away from the base being a smooth curve.

14. The LED lamp of claim 9, wherein a height of the convex portion is less than a height of each of the two fin branches at two lateral sides of the convex portion.

15. The LED lamp of claim 9, wherein a height of the convex portion gradually decreases from the first end to the second end of the each fin branch.

16. The LED lamp of claim 9, wherein two annular side walls extend from outer edges of a second face of the base opposite to the fins, an inner one of the two annular side walls and the second face of the base cooperatively forming a receiving groove therebetween, the LEDs being received in the receiving groove.

17. The LED lamp of claim 16, wherein one of the LEDs is located to be correspondent to the convex portion.
